(19) United States
(12) Patent Application Publication
(10) Pub. No.: US 2018/0013176 A1
(43) Pub. Date: Jan. 11, 2018

(54) MODULAR BATTERY PACK

(71) Applicant: VORBECK MATERIALS CORP., JESSUP, MD (US)

(72) Inventors: joseph ROY-MAYHEW, boston, MA (US); Mathew HUDSPETH, cantonsville, MD (US); charles HALVORSON, portland, ME (US)

(73) Assignee: VORBECK MATERIALS CORP., JESSUP, MD (US)

(21) Appl. No.: 15/540,559

(22) PCT Filed: Oct. 26, 2015
(86) PCT No.: PCT/US2015/057360

§ 371 Date: Aug. 22, 2017

Related U.S. Application Data
(60) Provisional application No. 62/069,789, filed on Oct. 28, 2014.

(51) Int. Cl. H01M 10/42; H01M 2/20; H01M 2/10

(52) U.S. Cl. CPC H01M 10/4257; H01M 2/1016; H01M 2/20

(57) ABSTRACT

Embodiments of the present invention relate to modular devices. The modular device comprises an enclosure having a main body and an extending member. A battery positioned at least within the main body. The extending member includes a coupling element. The coupling element is designed to provide electrical communication with another extending member when the extending member and the other extending member are in communication with each other. The coupling element is designed to provide structural support when in communication with the other extending member. The coupling element is in electrical communication with the battery. The modular device is designed in a manner to couple with another modular device via the coupling element.

### CROSS-REFERENCE TO RELATED APPLICATIONS

This application is a 371 application to international application PCT/US15/57360 filed Oct. 26, 2015, which claims priority to Provisional Application No. 62/069,789 filed Oct. 28, 2014.

### BACKGROUND

The present invention relates generally to batteries and power systems and specifically to modular battery packs. Electrical batteries are devices that may consist of one or more electrochemical cells that convert stored chemical energy into electrical energy. Batteries can be classified into primary and secondary forms. Primary batteries typically irreversibly transform chemical energy to electrical energy. Secondary batteries can be recharged, wherein the chemical reactions can typically be reversed by supplying electrical energy to the one or more electrochemical cells, thereby restoring their original composition.

### BRIEF DESCRIPTION OF THE DRAWINGS

FIG. 1 depicts a top view of two interconnectable modular units, in accordance with an embodiment of the present invention.

FIG. 2 depicts a top view of two interconnectable modular units, in accordance with an embodiment of the present invention.

FIG. 3 depicts a top view of two interconnectable modular units, in accordance with an embodiment of the present invention.

FIG. 4 depicts an interconnectable modular unit, generally 400, in accordance with an embodiment of the present invention.

FIG. 5 depicts a modular apparatus, generally 500, in accordance with an embodiment of the present invention.

FIG. 6 depicts a wiring diagram, generally 600, in accordance with an embodiment of the present invention.

FIG. 7 depicts a wiring diagram, generally 700, in accordance with an embodiment of the present invention.

FIG. 8 depicts a wiring diagram, generally 800, in accordance with an embodiment of the present invention.

FIG. 9 depicts a wiring diagram, generally 900, in accordance with an embodiment of the present invention.

FIG. 10 depicts a modular interconnectable modular unit, generally, 1000, in accordance with an embodiment of the present invention.

### DETAILED DESCRIPTION

The descriptions of the various embodiments of the present invention are presented for purposes of illustration and are not intended to be exhaustive or limited to the embodiments disclosed. Many modifications and variations will be apparent to those of ordinary skill in the art without departing from the scope and spirit of the described embodiments. The terminology used herein is chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, and the terms “downstream” and “upstream” referring, respectively, to directions in and opposite that of fluid flow. As used herein the terms “proximal” and “distal” refer to the top and bottom of the illustration, respectively. Terminology of similar import other than the words specifically mentioned above likewise is to be considered as being used for purposes of convenience rather than in any limiting sense.

Electrical batteries are devices that may consist of one or more electrochemical cells that convert stored chemical energy into electrical energy. Batteries can be classified into primary and secondary forms. Primary batteries can irreversibly transform chemical energy to electrical energy. As the supply of reactants is exhausted, energy typically cannot be restored to the battery. Secondary batteries can be recharged, wherein the chemical reactions are reversed by supplying electrical energy to the cell, thereby restoring their original composition. Battery systems, in particular rechargeable batteries, are often custom designed and manufactured for a particular purpose, tool, or end use. As used herein, the term “battery” refers to primary and secondary batteries comprised of one or more electrochemical cells that are connected in parallel or series.

Embodiments of the present invention seek to provide modular battery units that can be coupled together to enhance electrical output and/or provide a particular functionality. Other aspects of the present invention seek to provide flexible battery systems. Additional aspects of the present invention seek to provide modular battery units that incorporate electronic devices.

Modular battery units of the present invention are comprised of interconnectable modular units (hereinafter “IMUs). IMUs can comprise one or more batteries. Batteries can comprise lithium, nickel, cadmium, lead, alkaline, zinc, silver, their associated ions, and/or other applicable chemistries. IMUs have enclosures that act as housings for the below mentioned elements. Enclosures can provide storage space for user items. Enclosures may be comprised of one or more polymers, metals, cellulose, wood, ceramics, fabrics, and/or composites. IMUs can comprise storage compartments. Enclosures can comprise one or more extending members. IMU are defined as primary or secondary. Primary and/or secondary IMUs can have one or more mono-directional or bi-directional I/O ports (hereinafter “ports”). For example, ports can be used to provide power, accept power, and/or data communication. Primary IMUs are interconnectable with secondary IMUs. Secondary IMUs are interconnectable with both primary and other secondary IMUs. IMUs comprise at least one extending member. Extending members can have uniform lengths to facilitate their interchangeability. The length of complementary IMU's extending members are uniform to facilitate interchangeability. Extending members can have at least one coupling element. Coupling elements allow IMUs to be selectably coupled to the extending members of other IMUs. Coupling elements can include apertures and/or appendages magnet, connectors, fasteners, plug and cord. Coupling elements can have complementary structures. Coupling elements may be spring loaded

Coupling elements can be circular or polygonal in shape. Upon coupling, IMUs can pivot freely about axes made by the coupling elements. The degree of pivot freedom can be at least about 1° to about 90° as well as any sub-range therein. Coupling elements can comprise connectors, socket connectors, pin connectors, header connectors, and/or housing/receptacle connectors. Coupling elements can comprise pairs of interconnecting complementary structures. Coupling elements can allow electrical and/or data communication between interconnected IMUs.

IMUs can comprise one or more electronic devices that are in electrical communication with the one or more batteries. Electrical devices include, but not limited to, media players/recorders, fitness trackers, speakers, microphones, accelerometers, gesture recognition devices, geo-spatial devices, input devices, output devices, solar cells, voltage/current sensors, temperature sensors, radio transceivers, radio receivers, radio transmitters, and/or data stores. Electronic devices may provide radio-based communications.

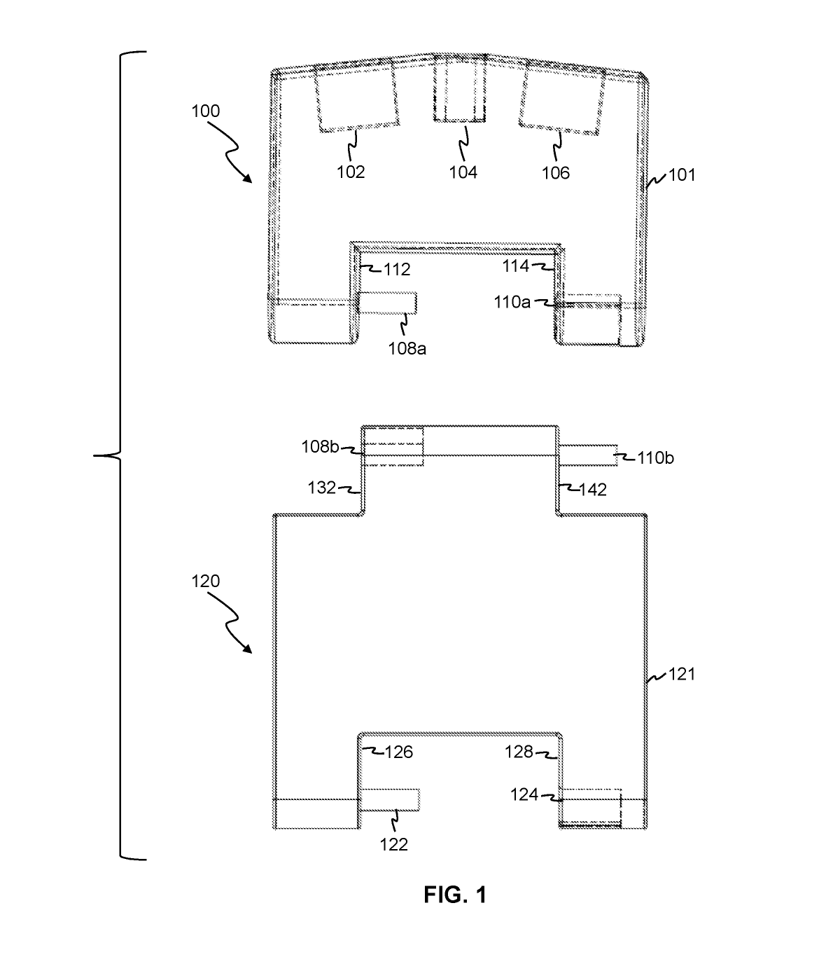

FIG. 1 depicts a top view of two IMUs, generally 100 and 120, in accordance with an embodiment of the present invention. IMU 100 is a primary IMU. IMU 100 can include enclosure 101. IMU 100 can include ports 102, 104, and/or 106 on the proximal end. Although not shown, enclosure 101 may include additional or less ports than depicted. Unit 100 can comprise a battery that is in electrical communication with a circuit and ports 102, 104, and/or 106.

IMU 100 can include a left and a right distal extending member separated by a spacing having a width that is at least the width of the proximal extending member of IMU 120 (discussed below). Here, the left distal extending member members has a right facing interior surface, surface 112, and the right distal member has a left facing interior surface, surface 114. Surfaces 112 and 114 are oriented towards each other. Appendage 108a extends from surface 112 and the entry for aperture 110a is positioned on surface 114. IMU 120 is a secondary IMU that can connect to additional copies of IMU 121 or IMU 101, in accordance with an embodiment of the present invention. Unit 120 can include enclosure 121. Although not shown, enclosure 121 can include one or more batteries and/or electronic devices. IMU 120 has a proximal extending member having exterior facing surfaces 132 and 142. Surface 132 has a left facing orientation and includes an opening for aperture 108b. Surface 142 has a right facing orientation and includes appendage 110b. IMU 120 includes a left and right distal extending members having interior surfaces 126 and 128, respectively. Interior surfaces 126 and 128 are oriented towards each other. Appendage 122 extends from exterior surface 126. Aperture 124 extends from exterior surface 128.

Copies of IMU 120 may be interconnected by coupling aperture 108b and appendage 110b of one copy to appendage 122 and aperture 124 of the other copy.

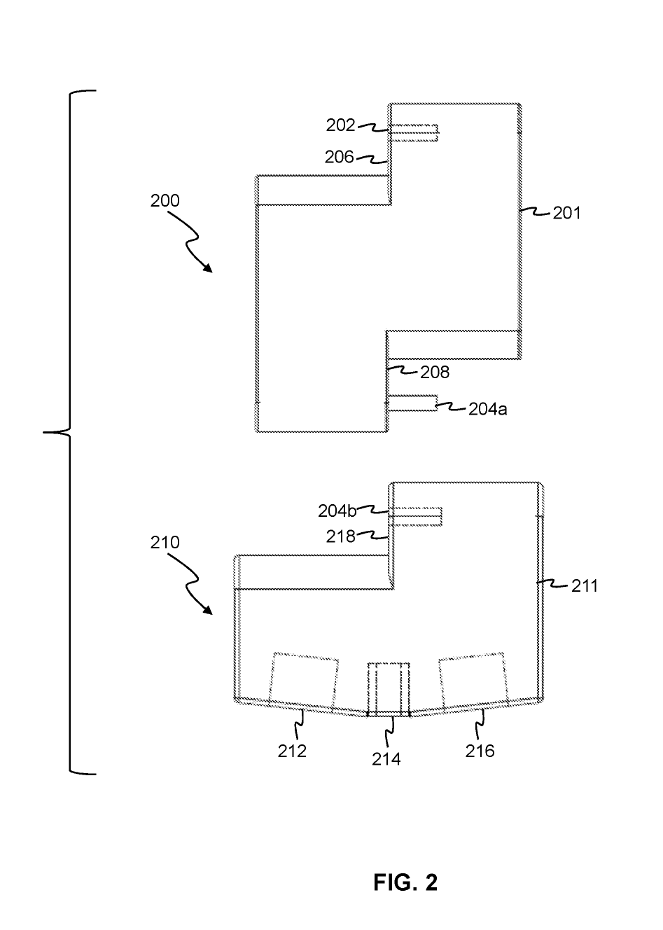

FIG. 2 depicts a top view of two IMUs, generally 200 and 210, in accordance with an embodiment of the present invention. IMU 210 is a primary IMU. IMU 200 is a secondary IMU. IMUs 200 and 210 include enclosures 201 and 211, respectively. Each IMU comprises proximal and distal ends. IMU 200 includes a proximal extending member having a surface 206 that is oriented to the left of IMU 200. IMU 200 includes a distal extending member having a surface 208 that is oriented to the right of IMU 200. The proximal and distal extending members of IMU 200 have a width that is about half the horizontal length of IMU 200. Surface 206 comprises an orifice for aperture 202. Appendage 204a extends from surface 208. Copies of IMU 200 can be coupled together via inserting appendage 204a of one copy in to aperture 202 of another copy.

The proximal end of IMU 210 comprises an extending member comprising a leftward oriented surface, surface 2018, that includes an orifice for aperture 204b. The width of the extending members of IMUs 200 and 210 can be uniform. In certain embodiments, only the width of one extending member of IMU 200 is equal to the width of the extending member of IMU 210. The distal end of IMU 210 can include ports 212, 214, and/or 216.

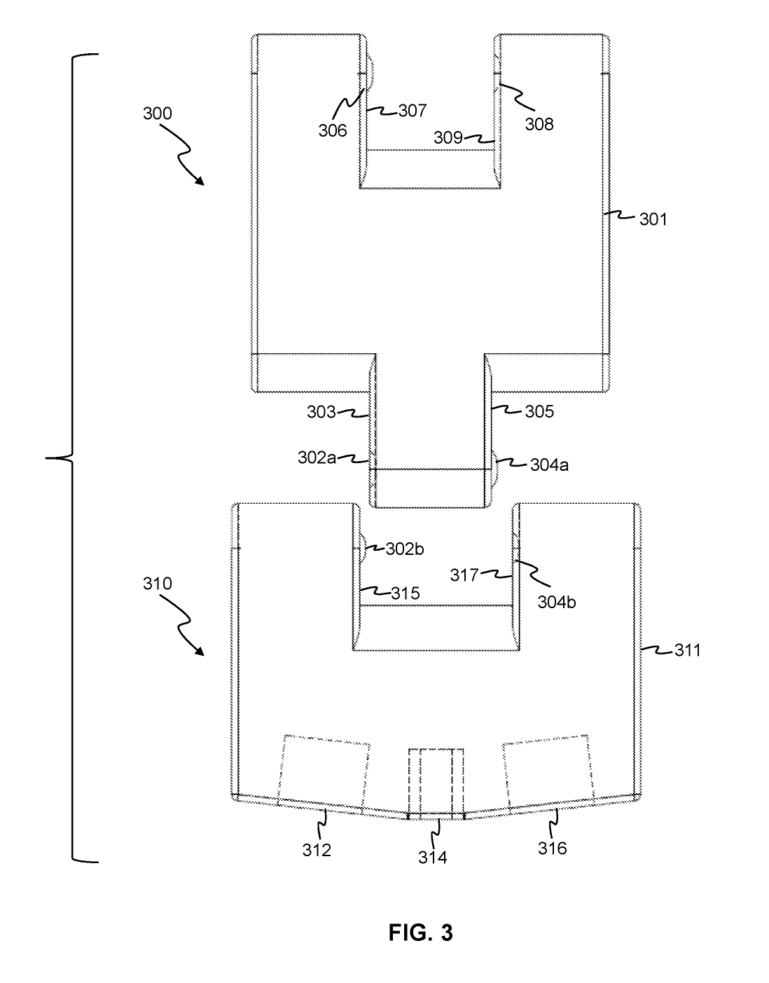

FIG. 3 depicts a top view of two IMUs, generally 300 and 310, in accordance with an embodiment of the present invention. IMUs 310 and 300 are primary and secondary IMUs, respectively. IMUs 300 and 310 include enclosures 301 and 311, respectively, which each have proximal and distal ends. The proximal end of IMU 300 can include a left and a right upward extending members extending opposite of the single distal extending member, which extends down. The interior-facing surfaces of the left and the right proximal extending members, surfaces 307 and 309, are positioned in a rightward and leftward orientation, respectively. Surfaces 307 and 309 are separated by a spacing having a width that that accepts the distal extending member of other copies of IMU 300.

Surfaces 307 and 308 can include appendage 306 and aperture 308, respectively. The distal extending member of IMU 300 has left and right exterior surfaces, surfaces 303 and 305, that includes aperture 302a and appendage 304a, respectively.

Appendage 306 can be a protrusion that is compatible with aperture 302a (discussed below), which may be a complementing indentation. IMU 310 includes enclosure 311, which includes proximal and distal ends. The distal end of enclosure 311 can include ports 312, 314, and/or 316. The proximal portion of IMU 310 includes left and right proximal extending members having interior surfaces, surfaces 315 and 317. Surfaces 315 and 317 are oriented towards each other. Surfaces 315 and 317 are separated by a spacing having a width that accommodates the distal extending member of IMU 300. Appendages 306, 304a, and/or 302b may comprise similar structures. Apertures 308, 302a, and/or 304b may comprise similar structures. Appendages 306, 304a, and/or 302b may comprise structures that are complementary to apertures 308, 302a, and/or 304b. To couple IMUs 300 and 310 together, appendages 302b and 304a are positioned in a manner to engage apertures 302a and 304b, respectively.

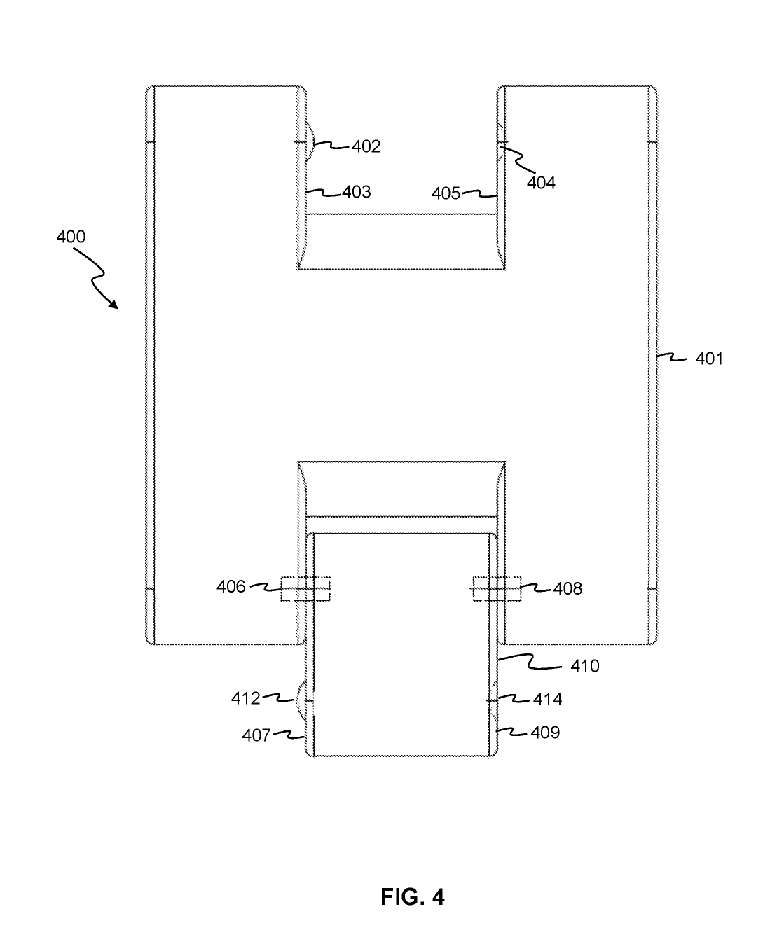

FIG. 4 depicts an IMU, generally 400, in accordance with an embodiment of the present invention. IMU 400 can be designed to have apertures and appendages that are compatible with IMUs 310 and 100 (discussed above). IMU 400 includes enclosure 401 and element 410. Enclosure 401 includes left and right proximal extending members, which extend in an upward fashion. Enclosure 401 includes left and right distal extending members, which extend in a downward fashion. Element 410 may be rotationally attached to enclosure 401 via linking elements 406 and 408, which are positioned on the left and right distal extending members of IMU 400 (discussed below), respectively.

The left and right proximal extending members of enclosure 401 have interior facing surfaces, surfaces 403 and 405, that are oriented towards each other. Surfaces 403 and 405 are separated by a spacing. The spacing has a width that can accommodate the distal end of element 410. The distal end of element 410 comprises surfaces 407 and 409, which include appendage 412 and aperture 414, respectively. Appendages 402 and 412 can complement apertures 414 and 404, respectively. Linking elements 406 and 408 may be at least partially positioned within the proximal extending members of enclosure 401. Linking elements 406 and 408 can allow the distal end of enclosure 401 and the proximal end of element 410 to rotate about one another in a manner that provides a desired degree of freedom, for example, at least about 5° to about 90°.

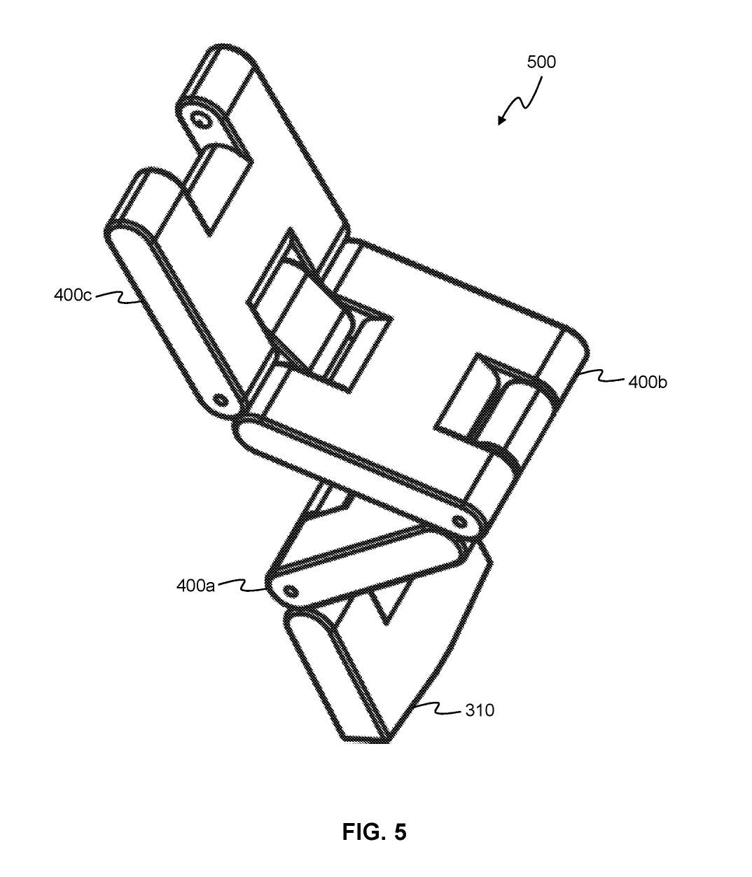

FIG. 5 depicts a modular apparatus, generally 500, in accordance with an embodiment of the present invention. Apparatus 500 can include multiple copies of IMU 400 coupled together, namely IMU 400b, which is connected to both IMUs 400a, and 400c (as discussed above). IMU 400a is further coupled to IMU 310 (as discussed above). Although not shown, apparatus 500 may include additional or less copies of IMU 400.

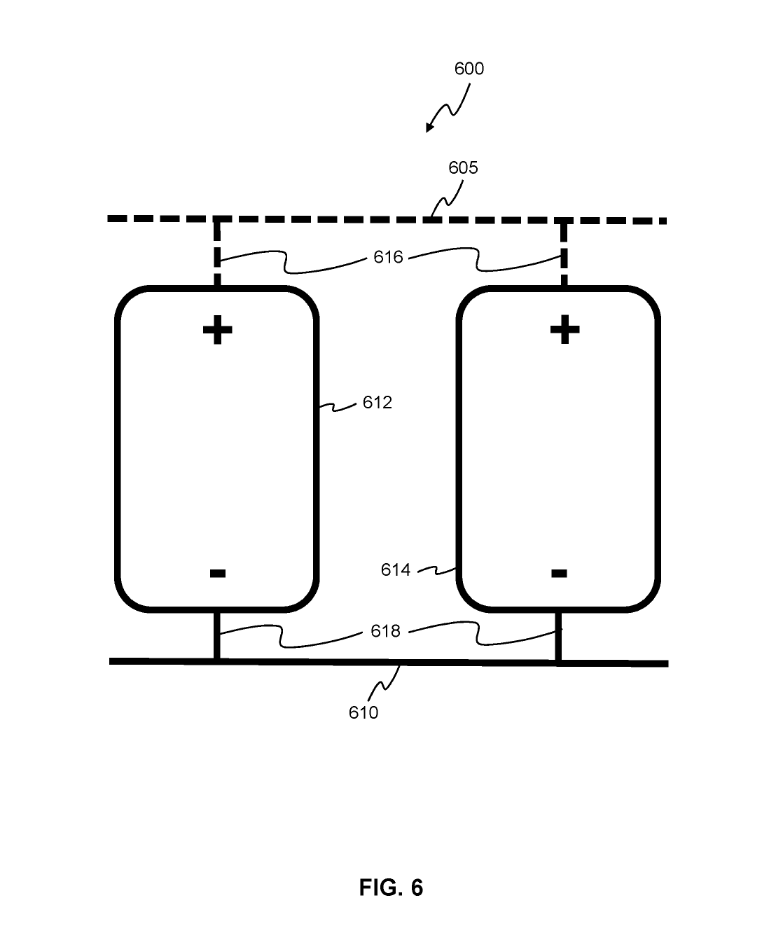

FIGS. 6-9 depict applicable battery wiring schemes for IMU interconnectivity. FIG. 6 depicts a wiring diagram, generally 600, in accordance with an embodiment of the present invention. Wiring diagram 600 illustrates an electrical communication scheme involving two interconnecting IMUs of the present invention, wherein each IMU comprises a power source, batteries 612 and 614, and associated wiring elements. Batteries 612 and 614 can be wired in parallel to cathode 605 (dashed line) and anode 610 via lines 616 (dashed line) and 618, respectively. Lines 616 and 618 can be at least partially positioned within apertures and appendages (i.e. connecting elements). Although not depicted, batteries 612 and 614 may be wired in series.

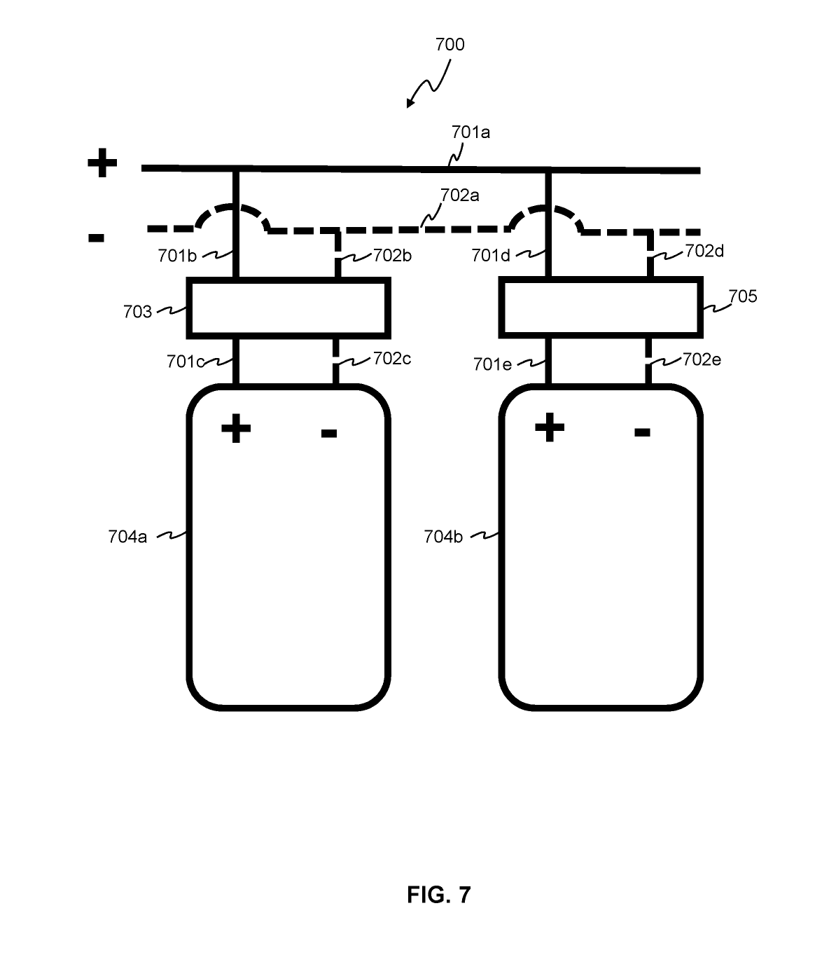

FIG. 7 depicts a wiring diagram, generally 700, in accordance with an embodiment of the present invention. Wiring diagram 700 illustrates an electrical communication scheme involving two IMUs, wherein each IMU can comprise a battery (i.e. at least one) and associated wiring elements. Wiring diagram 700 depicts cathode 701a and anode 702a (dashed line). Circuit 703 is in electrical communication with cathode 701a and anode 702a by communications line 701b and 702b, respectively. Circuit 705 is in electrical communication with cathode 701a and anode 702a via communication lines 701d and 702d, respectively. Batteries 704a is in electrical communication with circuits 703 via lines 701c and 702c. Batteries 704b is in electrical communication with circuits 705 via lines 701e and 702e.

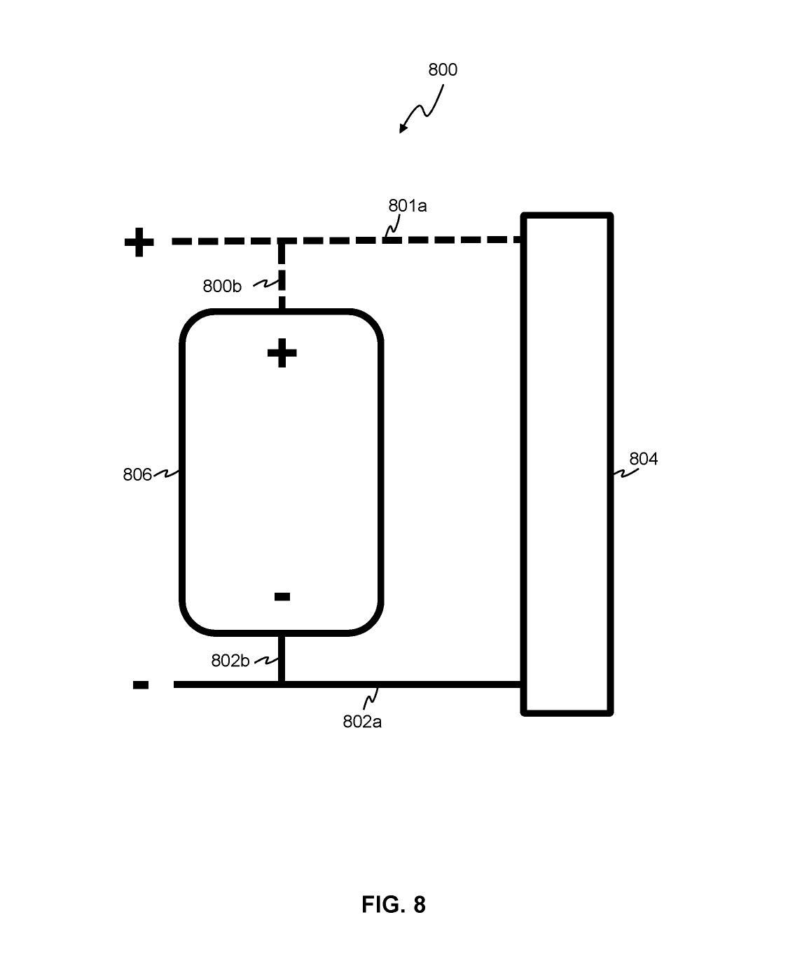

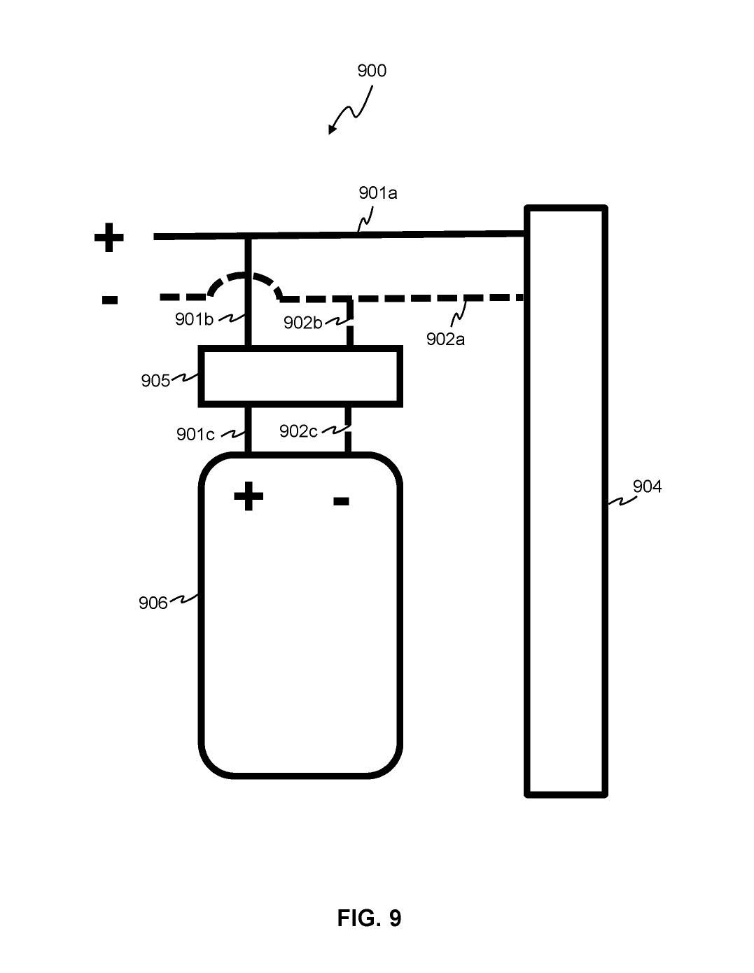

FIG. 8 depicts a wiring diagram, generally 800, in accordance with an embodiment of the present invention. Wiring diagram 800 illustrates battery 806, which is in parallel electrical communication with circuitry 804, for example an I/O controller, via lines 800a,b and 802a,b. FIG. 9 depicts a wiring diagram, generally 900, in accordance with an embodiment of the present invention. Wiring diagram 900 depicts battery 906, which is in electrical communication with circuitry 905 via lines 901c and 902c. Circuitry 905 can be a controller. Circuitry 905 is in further electrical communication with circuitry 904 via lines 901a,b and 902a,b. Circuitry 904 may comprise I/O circuitry. Lines 901a and 902a can provide data communication.

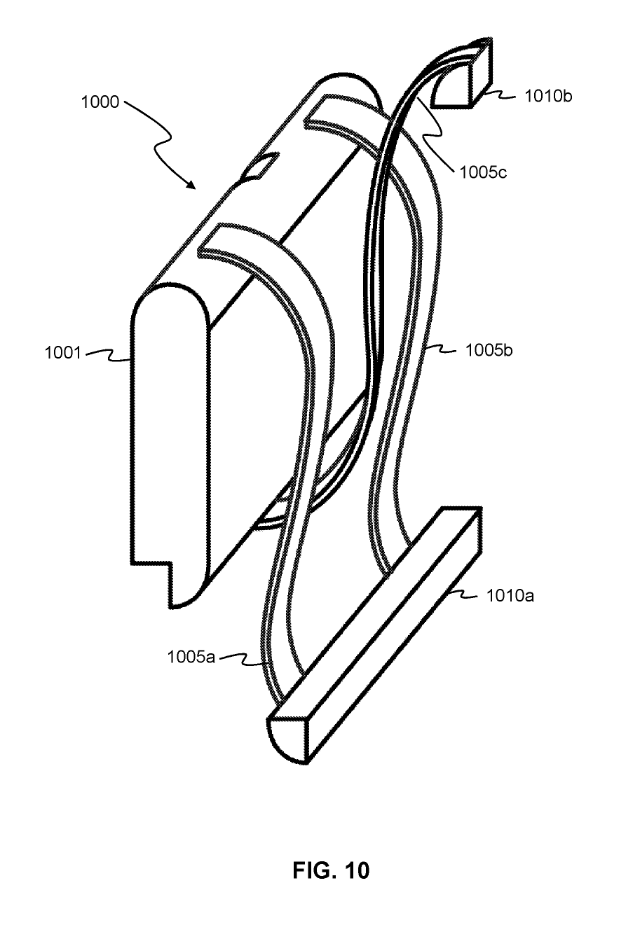

FIG. 10 depicts an IMU, generally 1000, in accordance with an embodiment of the present invention. IMU 1000 can utilize Jacob's ladder-type connectivity to with additional copies of IMU 1000. IMU 1000 includes enclosure 1001. IMU 1000 also includes wiring 1005a, b, and c, which can provide electrical and data communication between IMUs coupled thereto. Wiring 1005a,b extend from the top portion of IMU 1000. Wiring 1005c extends from the bottom portion of IMU 1000. To couple copies of IMU 1001 together, wiring 1005a,b and wiring 1005c of one copy are attached to the bottom and top portions of the other copy respectively. Wiring 1005a, b, and c together with connectors 1010a and b can provide structural support and/or electrical communication between interconnected copies of IMU 1000.

What is claimed is:

1. A modular device comprising:
an enclosure having a main body and an extending member extending from a side of the main body;
a battery positioned at least within the main body;
wherein the extending member includes a coupling element;
wherein the coupling element is designed to provide electrical communication with another extending member when the extending member and the other extending member are in communication with each other;
wherein the coupling element is designed to provide structural support when in communication with the other extending member;
wherein the coupling element is in electrical communication with the battery; and
wherein the modular device is designed in a manner to couple with another modular device via the coupling element.

2. The modular device of claim 1, further comprising a circuit in electrical communication with the battery and/or the coupling element.

3. The modular device of claim 2, wherein the circuit includes an electronic device.

4. The modular device of claim 2, wherein the coupling element is a connector, an aperture, an appendage, and/or a fastener.

5. The modular device of claim 1, wherein the enclosure is comprised of a polymer, a metal, a cellulose material, a wood material, a ceramic material, a fabric material, and/or a composite material.

6. The modular device of claim 1, wherein the connecting element is designed to provide a point of rotational pivot when the connecting element is in communication with another connecting element.

7. The modular device of claim 1, further comprising an I/O port at least partially positioned on a surface of the enclosure and in electrical communication with the battery.

8. The modular device of claim 1, wherein the connecting element comprises a spring mount.

9. A modular power system comprising:
a first copy of the modular device of claim 1;
a second copy of the modular device of claim 1;
wherein the first and the second copies of the modular device of claim 1 are coupled together via their coupling elements.

10. The modular power system of claim 9, wherein the coupling elements of the first and second copy of the modular device of claim 1 provided by a pivot axis about which the first and second copy of the modular device of claim 1 can rotate.

11. A modular device comprising:
an enclosure;
a battery positioned within the enclosure;
a plurality of appendages in electrical communication with the battery;
wherein the plurality of appendages allow the enclosure to connect to an additional enclosure;
wherein the plurality of appendages provide a Jacob's ladder connectivity between the enclosure and the additional enclosure; and
wherein at least one appendage in the plurality of appendages is designed to provide electrical communication and/or data communication with the additional enclosure.

12. The device of claim 11, further comprising a circuit in electrical communication with the battery and/or an appendage included in the plurality of appendages.

13. The device of claim 12, wherein the circuit includes an electronic device.

14. The device of claim 11, further comprising an I/O port at least partially positioned on a surface of the enclosure and in electrical communication with the battery.

15. The device of claim 11, wherein the enclosure is comprised of a polymer, a metal, a cellulose material, a wood material, a ceramic material, a fabric material, and/or a composite material.

16. The device of claim 11, wherein the appendage comprises a magnet and/or a spring mount.

17. The device of claim 12, further comprising an insulated storage area positioned within the enclosure.

18. The device of claim 13, wherein the electronic device is one or more of an audio player, a video player, a fitness tracker, an accelerometer, a location device, a radio frequency identification sensor, an input device, a solar cell, a speaker, a wireless data communication module, a transceiver, a processor, and memory module.

19. The modular device of claim 3, wherein the electronic device is one or more of an audio player, a video player, a fitness tracker, an accelerometer, a location device, a radio frequency identification sensor, an input device, a solar cell, a speaker, a wireless data communication module, a transceiver, a processor, and memory module.
